(19) United States
(12) Patent Application Publication
(10) Pub. No.: US 2025/0159300 A1
(43) Pub. Date: May 15, 2025

(54) DISPLAY DEVICE SETTINGS SIZES

(71) Applicant: Hewlett-Packard Development Company, L.P., Spring, TX (US)

(72) Inventors: Alexander Morgan Williams, Spring, TX (US); David Michael Nypaver, Spring, TX (US); Anthony Kaplanis, Spring, TX (US)

(21) Appl. No.: 18/840,055

(22) PCT Filed: Feb. 23, 2022
(86) PCT No.: PCT/US2022/017559

§ 371 Date: Aug. 20, 2024

(51) Int. Cl. H04N 21/475; G06F 3/01; G06F 3/16; H04N 21/485

(52) U.S. Cl. CPC H04N 21/4755; G06F 3/013; G06F 3/167; H04N 21/4854

(57) ABSTRACT

In some examples, a display device includes a controller to receive an image from an image sensor, determine a user is visually impaired utilizing the image, and, in response to determining that the user is visually impaired, adjust a size of a graphical user interface (GUI) for adjusting settings of the display device.

### BACKGROUND

Display devices include menus that enable users to adjust settings of the display devices. Options of a menu are displayed on the display device as text, icons, or a combination thereof.

### BRIEF DESCRIPTION OF THE DRAWINGS

Various examples are described below referring to the following figures.

FIG. 1 is a block diagram of an electronic device for adjusting display device settings sizes, in accordance with various examples.

FIG. 2 is a block diagram of a display device for adjusting display device settings sizes, in accordance with various examples.

FIGS. 3A and 3B are images used for adjusting display device settings sizes, in accordance with various examples.

FIG. 4 is a block diagram of a display device adjusting display device settings sizes, in accordance with various examples.

FIGS. 5A and 5B are block diagrams of display device settings sizes for a display device, in accordance with various examples.

FIG. 6 is a block diagram of display device settings sizes, in accordance with various examples.

FIG. 7 is a flow diagram of a method for adjusting display device settings sizes, in accordance with various examples.

FIG. 8 is a block diagram of a display device adjusting display device settings sizes, in accordance with various examples.

FIG. 9 is a block diagram of an electronic device adjusting display device settings sizes, in accordance with various examples.

### DETAILED DESCRIPTION

As described above, a display device includes a menu that enables a user to adjust settings of the display device. The menu includes options for selecting a video input source, a power management setting, a performance setting, a picture-in-picture setting, a data channel, or a factory reset, for instance. The menu is accessible via a graphical user interface (GUI) and options of the menu are displayed on the display device as text, icons, or a combination thereof, for instance. Governmental standards or regulations establish that the text, the icons, or the combination thereof, of the display device are adjustable for visually impaired users. Some electronic devices that couple to the display device include executable code that enable the user to navigate the menu of the display device via a graphical user interface (GUI) having scalable text and icons. However, the executable code is dependent on an operating system (OS) of the electronic device.

Absence of the electronic device including the executable code results in the display device not complying with the governmental standards or regulations. An inability to read the text, the icons, or the combination thereof, results in the user leaning in toward the display device. In some instances, the increased proximity to the display device interferes with user access to other input/output (I/O) devices utilized with the display device. The increased proximity to one area of the display device interferes with the user ability to view other areas of the display device simultaneously. The interference with access to I/O devices and the inability to view the entire display device simultaneously each reduce user experience.

This description describes a display device that includes an image sensor to detect a user is visually impaired. The image sensor captures an image of the user. In some examples, a controller determines a distance between the user and the image sensor utilizing the image of the user. In some examples, the image sensor captures multiple images of the user, and the controller determines the distances between the user and the image sensor to detect user motion relative to the display device. In other examples, the controller analyzes the image to detect an eye anomaly of the user. In response to a determination that the user is within a threshold distance, moving closer to the display device, has the eye anomaly, or a combination thereof, the controller determines that the user is visually impaired. In response to the determination that the user is visually impaired, the controller adjusts a size of the menu of the display device. Adjusting the size of the menu of the display device includes adjusting a size of the options of the menu for selecting settings of the display device. In some examples, in response to the determination that the user is visually impaired, the controller causes a text-to-speech executable code to play a description of the menu, a description of the GUI that enables access to the menu, the text of the menu, a description of the icons of the menu, or a combination thereof.

By utilizing the display device that includes the image sensor to detect the visually impaired user and adjust menu settings in response to the detection, the display device complies with the governmental standards or regulations. Adjusting the size of the menu of the display device enhances the user experience by enabling the user to access I/O devices and view other areas of the display device. Enabling the text-to-speech executable code enhances the user experience and places the display device in compliance with the governmental standards or regulations.

In some examples in accordance with the present description, a display device is provided. The display device includes a controller to receive an image from an image sensor, determine a user is visually impaired utilizing the image, and, in response to determining that the user is visually impaired, adjust a size of a graphical user interface (GUI) for adjusting settings of the display device.

In other examples in accordance with the present description, a display device is provided. The display device includes an image sensor and a controller. The controller receives an indicator from an electronic device coupled to the display device, and in response to the indicator, receives an image from the image sensor. The controller determines a user is visually impaired utilizing the image, and in response to determining that the user is visually impaired, determines a scaling to apply to a size of a graphical user interface (GUI) for adjusting settings of the display device based on the indicator. The controller causes a display of the GUI having the scaling.

In yet other examples in accordance with the present description, a display device is provided. The display device includes a storage device to store a first configuration and a second configuration of a graphical user interface (GUI) for adjusting settings of the display device, and a controller coupled to the storage device. The first configuration is associated with a first range and the second configuration is associated with a second range. The controller determines a measurement utilizing an image captured by an image sensor. In response to the measurement being within the first range, the controller enables the first configuration. In response to the measurement being within the second range, the controller enables the second configuration.

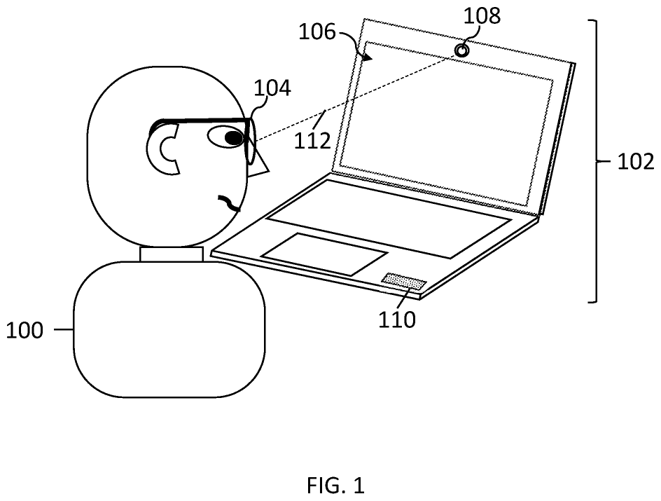

Referring now to FIG. 1, a block diagram of an electronic device 102 for adjusting display device settings sizes is shown, in accordance with various examples. A user 100 faces the electronic device 102. The user 100 is wearing a pair of eyeglasses 104. The electronic device 102 includes a display device 106, an image sensor 108, and an audio device 110. The electronic device 102 is a desktop, a laptop, a notebook, a tablet, a smartphone, or any other suitable computing device including the display device 106. The display device 106 is a liquid crystal display (LCD), a light-emitting diode (LED) display, a plasma display, a quantum dot (QD) LED display, an organic LED (OLED) display, or any suitable device for displaying data of the electronic device 102. The image sensor 108 is an internal camera, an external camera, or any other suitable device for capturing an image, recording a video signal, or a combination thereof. The image sensor 108 is an infrared (IR) camera, a time of flight (ToF) sensor, or an ultrasonic camera, for example. The audio device 110 is any suitable device for playing sound. The audio device 110 is a speaker, for example.

While not explicitly shown, the electronic device 102 includes processors, controllers, network interfaces, video adapters, sound cards, local buses, input/output devices (e.g., a keyboard, a mouse, a touchpad, a microphone), storage devices, wireless transceivers, connectors, or a combination thereof. While the display device 106 is shown as an integrated display device of the electronic device 102, in other examples, the display device 106 is coupled to the electronic device 102 via a wired connection (e.g., USB, Video Graphics Array (VGA), Digital Visual Interface (DVI), High-Definition Multimedia Interface (HDMI), DisplayPort (DP), Serial Digital Interface (SDI), Network Device Interface (NDI)) or is a stand-alone display device coupled to the electronic device 102 via a wireless connection (e.g., BLUETOOTH®, WI-FI®), for example. While the image sensor 108 is shown as an integrated image sensor of the electronic device 102, in other examples, the image sensor 108 couples to any suitable connection for enabling communications between the electronic device 102 and the image sensor 108. The connection may be via a wired connection (e.g., a Universal Serial Bus (USB)) or via a wireless connection (e.g., BLUETOOTH®, WI-FI®), for example. While the audio device 110 is shown as an integrated audio device of the electronic device 102, in other examples, the audio device 110 couples to any suitable connection for enabling communications between the electronic device 102 and the audio device 110. The connection may be via a wired connection (e.g., a Universal Serial Bus (USB)) or via a wireless connection (e.g., BLUETOOTH®, WI-FI®), for example.

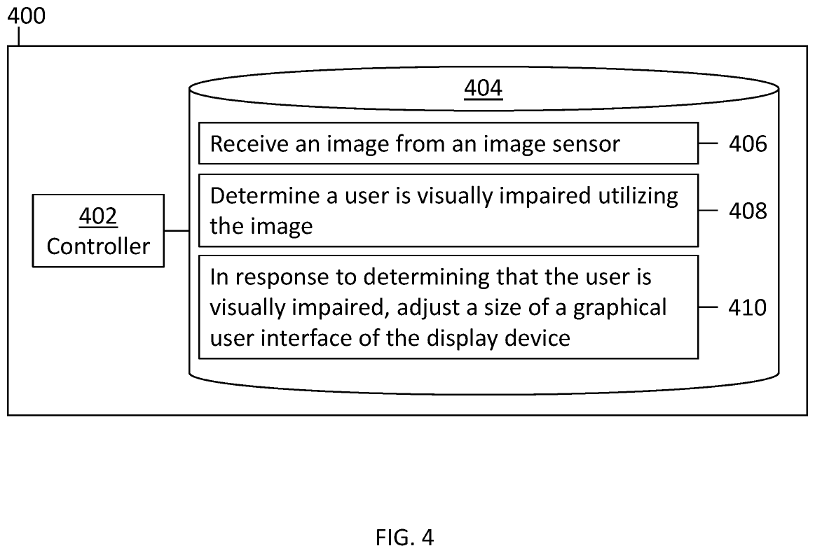

In various examples, as described below with respect to FIG. 4, 8, or 9, the display device 106 is coupled to the image sensor 108 and the audio device 110 via a controller. The controller is a microcontroller, a microprocessor, a microcomputer, or other suitable device for managing operations of the display device 106. The controller is a central processing unit (CPU), a graphics processing unit (GPU), a system on a chip (SoC), an image signal processor (ISP), or a field programmable gate array (FPGA), for example. In some examples, the display device 106 includes a storage device storing machine-readable instructions, as described below with respect to FIG. 4, 8, or 9. In various examples, when executed by the controller, the machine-readable instructions cause the controller to utilize the image sensor 108 to detect that the user 100 is visually impaired and adjust a size of the menu for adjusting settings of the display device 106. In some examples, when executed by the controller, the machine-readable instructions cause the controller to utilize the audio device 110 to play speech associated with the menu for adjusting settings of the display device 106. For example, the audio device 110 plays a description of the menu, a description of the GUI that enables access to the menu, the text of the menu, a description of the icons of the menu, or a combination thereof.

As described above, in some examples, the display device 106 includes the image sensor 108 to detect the user is visually impaired. The image sensor 108 captures an image of the user 100. In various examples, the controller determines that the user 100 is wearing a pair of eyeglasses 104 to detect that the user is visually impaired. To determine whether the image includes the pair of eyeglasses 104, the controller uses a facial detection technique to detect the user 100 in the image, for example. The facial detection technique is an appearance-based model that utilizes statistics, machine learning techniques, or a combination thereof, a knowledge-based model that uses a set of rules, a feature-based model that extracts features of the image, a template-based model that correlates features of the image to templates of faces, or a combination thereof, for example. The facial detection technique determines whether a face is in the image.

In some examples, the controller analyzes the image to determine whether the image includes a feature of the pair of eyeglasses 104. The feature of the pair of eyeglasses 104 is a frame, an arm, a lens, a rim, a nose pad, a bridge, or a combination thereof, for example. Responsive to a determination that the image includes the feature of the pair of eyeglasses 104, the controller determines that the image includes the pair of eyeglasses 104. In other examples, to determine whether the image includes the pair of eyeglasses 104, the controller analyzes the image utilizing a computer vision technique, a machine learning technique, or a combination thereof. The computer vision technique identifies a feature of the image, classifies the feature, compares the feature to multiple templates (e.g., images of pairs of eyeglasses), or a combination thereof. For example, the computer vision technique identifies an H-shaped feature of the image, classifies the H-shaped feature as a bridge of a pair of eyeglasses, compares the H-shaped feature to multiple templates of pairs of eyeglasses in different perspectives within a field of view of an image sensor, or a combination thereof. Responsive to a determination that the H-shaped feature indicates the pair of eyeglasses 104, the controller determines that the image includes the pair of eyeglasses 104.

In other examples, the controller uses a machine learning technique to determine whether a feature or a combination of features indicates a pair of eyeglasses. The machine learning technique compares the feature or the combination of features to multiple templates to determine that the feature or the combination of features indicates that the image includes the pair of eyeglasses 104. In various examples, the controller uses a machine learning technique that implements a convolution neural network (CNN) to determine whether the image includes the pair of eyeglasses 104. The controller uses the CNN trained with a training set that includes multiple images of multiple users. A subset of the multiple images may include people wearing pairs of eyeglasses and another subset of the multiple images may include people not wearing pairs of eyeglasses. Utilizing the trained CNN, the controller identifies multiple features of the image, classifies the features, and determines whether the image includes the pair of eyeglasses 104. In some examples, the CNN implements a Visual Geometry Group (VGG) network, a Residual Network (ResNet) network, a SqueezeNet network, or an AlexNet network.

In other examples, in response to a determination that the user 100 is wearing the pair of eyeglasses 104, the controller determines a distance 112 between the user 100 and the image sensor 108 utilizing the image of the user 100. For example, to determine the distance 112, the controller calculates the distance 112 utilizing a focal length of the image sensor 108, a width in pixels of a target object in the image, and a width of a marker object in the image. For example, the distance 112 is equivalent to a product of the width of the marker object and the focal length divided by the width in pixels of the target object. The controller multiples the width of the marker object and the focal length to determine the product. The controller divides the product by the width in pixels of the target object. The marker object is a body part of the user 100, such as a head, a face, an upper body, or some other suitable body part, for example. The target object is a facial feature of the user 100, such as eyes, a nose, a central point of a face, or some other suitable facial feature.

In some examples, the controller locates the marker object, the target object, or a combination thereof, utilizing image processing techniques. For example, the controller converts the image to grayscale, blurs the resulting grayscale to remove noise, and uses edge detection to detect the marker object, the facial feature, or the combination thereof. In various examples, the controller adjusts the distance 112 by compensating for distortions of the image sensor 108 that impact the image. The distortions include radial distortion and tangential distortion, for example. In other examples, the electronic device 102 includes light sensors. For example, the image sensor 108 is a light detection and ranging (LIDAR) camera that transmits light pulses and measures a time that is taken by the light pulses to bounce off an object and return to the image sensor 108.

In various examples, in response to a determination that the distance 112 is within a threshold distance, the controller detects that the user 100 is visually impaired. The threshold distance is stored to a storage device of the electronic device 102, the display device 106, or a combination thereof, at a time of manufacture, for example. In other examples, a GUI enables the user 100 to adjust the threshold distance. In some examples, the image sensor 108 captures multiple images of the user 100. The controller determines the distance 112 between the user 100 and the image sensor 108 for each image of the multiple images. The controller compares the multiple distances to determine whether the user 100 is nearing the display device 106. In response to a determination that the user 100 is nearing the display device 106, the controller detects that the user 100 is visually impaired.

In other examples, in response to a determination that the user 100 is wearing the pair of eyeglasses 104, the controller analyzes the image to detect an eye anomaly utilizing a computer vision technique, a machine learning technique, or the combination thereof. For example, the controller analyzes an area of the image that includes the pair of eyeglasses 104 to determine whether an eye feature of the user 100 is different than a specified parameter for the eye feature. The eye feature is a pupil, an iris, or other eye feature with specified parameters that have little variance across different people, for example. The specified parameter is set at a time of manufacture, for example. The computer vision technique identifies the eye feature, classifies the eye feature, compares the eye feature to multiple templates (e.g., images of the eye feature), or a combination thereof.

In some examples, the controller uses a machine learning technique to determine whether the eye feature includes the eye anomaly. The machine learning technique compares the eye feature or the combination of features to multiple templates to determine that the eye feature or the combination of eye features include the eye anomaly. The controller uses a CNN trained with a training set that includes multiple images of multiple eye features, for example. A subset of the multiple images includes people having the eye anomaly and another subset of the multiple images includes people not having the eye anomaly. In some examples, the training set includes multiple subsets of the multiple images including people having different types of eye anomalies. Utilizing the trained CNN, the controller identifies multiple eye features, classifies the multiple eye features, and determines whether the image includes the eye anomaly.

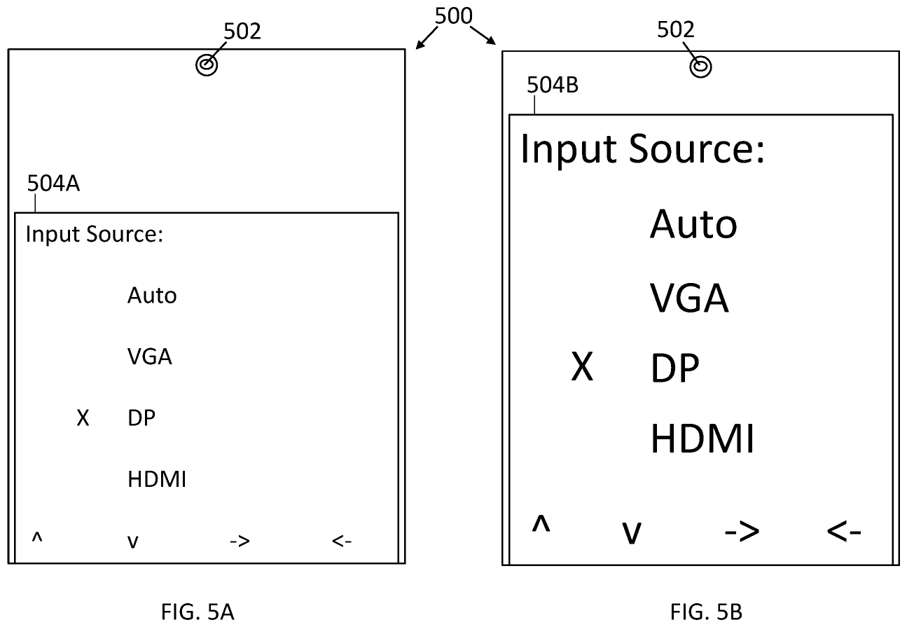

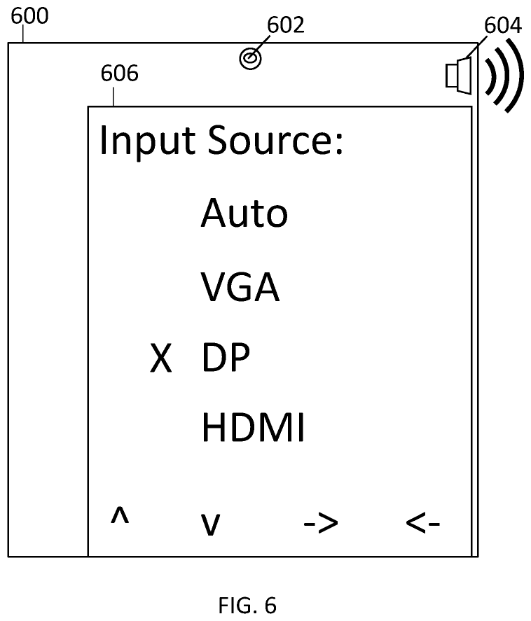

In response to a determination that the user 100 is within the threshold distance, moving closer to the display device 106, has the eye anomaly, or a combination thereof, the controller determines that the user 100 is visually impaired. In response to the determination that the user 100 is visually impaired, the controller adjusts a size of the menu of the display device 106, enables text-to-speech executable code of the display device 106, or a combination thereof. In some examples, the controller adjusts sizes of the menu for adjusting settings of the display device 106, as shown below in FIGS. 5B or 6. In various examples, the controller causes the audio device 110 to play the text-to-speech for displayed options of the menu for adjusting settings of the display device 106, selected options of the menu for adjusting settings of the display device 106, or a combination thereof.

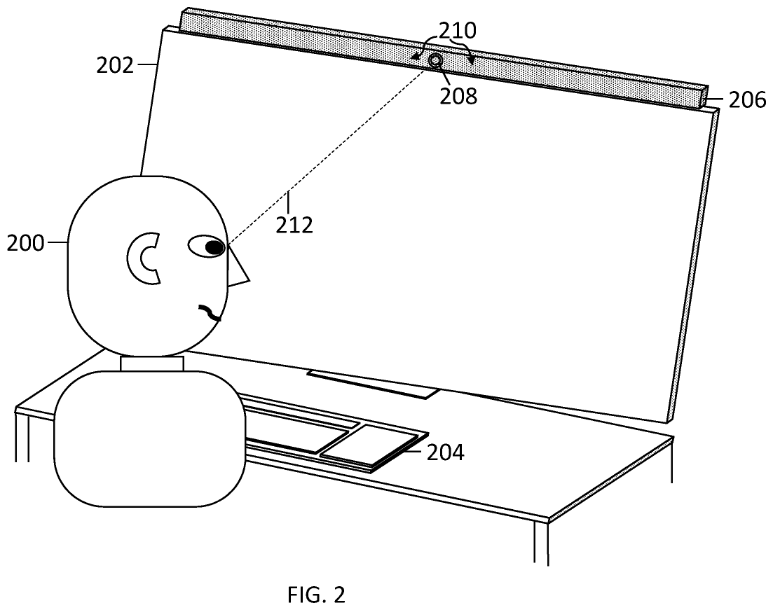

Referring now to FIG. 2, a block diagram of a display device 202 for adjusting display device settings sizes is shown, in accordance with various examples. The display device 202 is the display device 106, for example. A user 200 faces the display device 202. The user 200 is the user 100, for example. The display device 202 includes I/O devices 204, 206. An I/O device 204 is a keyboard, for example. An I/O device 206 is a media bar that plays sound and captures images. The I/O device 206 includes an image sensor 208 and an audio device 210. The image sensor 208 is the image sensor 108, for example. The audio device 210 is the audio device 110, for example.

As described above with respect to FIG. 1, in various examples, the I/O devices 204, 206 couple to any suitable connections for enabling communications between the display device 202 and the I/O devices 204, 206. The connections may be via wired connections (e.g., a Universal Serial Bus (USB)), via wireless connections (e.g., BLUETOOTH®, WI-FIQ), or a combination thereof, for example.

In some examples, as described below with respect to FIG. 4, 8, or 9, the display device 202 is coupled to the I/O devices 204, 206 via a controller. The controller is a microcontroller, a microprocessor, a microcomputer, or other suitable device for managing operations of the display device 202. The controller is a CPU, a GPU, an SoC, an ISP, or an FPGA, for example. In some examples, the display device 202 includes a storage device storing machine-readable instructions, as described below with respect to FIG. 4, 8, or 9. In various examples, when executed by the controller, the machine-readable instructions cause the display device 202 to utilize the image sensor 208 to detect the user 200 is visually impaired and adjust the sizes of the menu for adjusting settings of the display device 202. In some examples, when executed by the controller, the machine-readable instructions cause the display device 202 to utilize the audio device 210 to play speech associated with the menu for adjusting settings of the display device 202.

As described above, the display device 202 uses the image sensor 208 to detect whether the user 200 is visually impaired. The image sensor 208 captures an image of the user 200. In some examples, a controller of the display device 202, utilizing the techniques described above with respect to FIG. 1, determines a distance 212 between the user 200 and the image sensor 208 utilizing the image of the user 200. In some examples, the image sensor 208 captures multiple images of the user 200, and the controller determines the distance 212 between the user 200 and the image sensor 208 utilizing each image of the multiple images to detect user motion relative to the display device, as described above with respect to FIG. 1. In other examples, utilizing the techniques described above with respect to FIG. 1, the controller analyzes the image to detect an eye anomaly.

In response to a determination that the user 200 is within the threshold distance, moving closer to the display device 202, has the eye anomaly, or a combination thereof, the controller determines that the user 200 is visually impaired. In response to the determination that the user 200 is visually impaired, the controller adjusts a size of the menu for adjusting settings of the display device 202, enables text-to-speech executable code, or a combination thereof. In some examples, the controller adjusts the size of the menu for adjusting settings of the display device 202 as shown below in FIGS. 5B or 6. In various examples, the controller causes the audio device 210 to play the text-to-speech for displayed options of the menu, selected options of the menu, or a combination thereof.

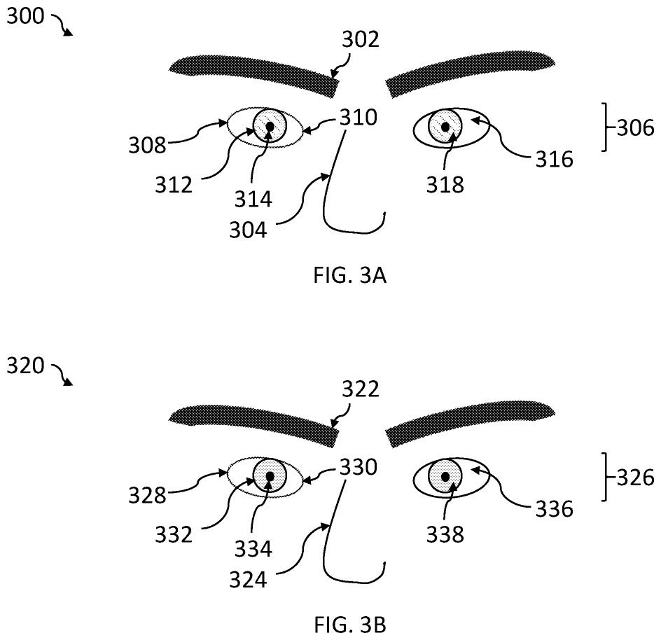

Referring now to FIG. 3A, an image 300 utilized for adjusting display device settings sizes is shown, in accordance with various examples. The image 300 includes facial features 302, 304, 306. A facial feature 302 is an eyebrow, for example. A facial feature 304 is a nose bridge, for example. A facial feature 306 is eyes, for example. The facial feature 306 includes eye features 308, 310, 312, 314, 316 and an eye anomaly 318. An eye feature 308 is an outer corner of an eye, for example. An eye feature 310 is an inner corner of the eye, for example. An eye feature 312 is an outer edge of an iris, for example. An eye feature 314 is a pupil, for example. An eye feature 316 is a sclera, for example. The eye anomaly 318 is a feature located in the eyes but not an eye feature 308, 310, 312, 314, 316.

Referring now to FIG. 3B, an image 320 utilized for adjusting display device settings sizes is shown, in accordance with various examples. The image 320 includes facial features 322, 324, 326. A facial feature 322 is an eyebrow, for example. A facial feature 324 is a nose bridge, for example. A facial feature 326 is eyes, for example. The facial feature 326 includes eye features 328, 330, 332, 334, 336, 338. An eye feature 328 is an outer corner of an eye, for example. An eye feature 330 is an inner corner of the eye, for example. An eye feature 332 is an outer edge of an iris, for example. An eye feature 334 is a pupil, for example. An eye feature 336 is a sclera, for example. An eye feature 338 is a central portion of the iris, for example.

Referring now to FIGS. 3A and 3B, in some examples described above with respect to FIG. 1, a controller utilizes a facial recognition technique to detect a face within the images 300, 320. For example, the controller analyzes the images 300, 320 to detect the facial features 302, 304, 306; 322, 324, 326, respectively. The controller analyzes the images 300, 320 to detect an eye anomaly within the eyes of a user (e.g., the user 100, 200) utilizing a computer vision technique, a machine learning technique, or the combination thereof, as described above with respect to FIG. 1 or 2. The controller is a controller of the electronic device 102, the display device 106, or the display device 202, for example. The controller analyzes an area of the image 300, 320 that indicates an area of the eyes to determine whether an eye feature of the user is different than a specified parameter for the eye feature. The controller identifies the facial features 302, 304; the facial features 322, 324 to identify the area of the eyes (e.g., the facial features 306, 326, respectively), for example.

In various examples, the controller identifies the eye features 308, 328 and the eye features 310, 330 to locate the eye features 312, 332, respectively, the eye features 314, 334, respectively, and the eye features 316, 336, respectively, for example. The controller determines a measurement for the iris, the pupil, the sclera, or a combination thereof. The controller compares the measurement to a specified parameter for the respective eye feature. In response to a determination that the measurement is not within the specified parameter, the controller determines that the eyes include the eye anomaly 318. For example, the eye anomaly 318 obscures the pupil such that a diameter of the pupil is less than the specified parameter. In other examples, the controller determines a color of the iris, the sclera, or a combination thereof deviates from a specified color by an amount greater than a specified parameter. In response to a determination that the color deviates by the amount greater than the specified parameter, the controller determines the eyes include the eye anomaly 318.

Referring now to FIG. 4, a block diagram of a display device 400 for adjusting display device settings sizes is shown, in accordance with various examples. The display device 400 is the display device 106, 202, for example. The display device 400 includes a controller 402 and a storage device 404. The controller 402 is a microcontroller, a microprocessor, a microcomputer, or other suitable device for managing operations of the display device 400. The controller 402 is a CPU, a GPU, an SoC, an ISP, or an FPGA, for example. The storage device 404 is a hard drive, a solid-state drive (SSD), flash memory, random access memory (RAM), or other suitable memory for storing data or machine-readable instructions of the display device 400.

In various examples, the controller 402 is coupled to the storage device 404. In some examples, the storage device 404 stores machine-readable instructions 406, 408, 410, which, when executed by the controller 402, cause the controller 402 to perform some or all of the actions attributed herein to the controller 402. For example, the machine-readable instructions 406, 408, 410, when executed by the controller 402, cause the controller 402 to determine a user (e.g., the user 100, 200) is visually impaired and adjust display device settings sizes in response to the determination the user is visually impaired.

In some examples, the machine-readable instruction 406, when executed by the controller 402, causes the controller 402 to receive an image (e.g., the image 300, 320) from an image sensor (e.g., the image sensor 108, 208). The machine-readable instruction 408, when executed by the controller 402, causes the controller 402 to determine a user (e.g., the user 100, 200) is visually impaired utilizing the image. In response to determining that the user is visually impaired, the machine-readable instruction 410, when executed by the controller 402, causes the controller 402 to adjust a size of a GUI (e.g., the GUI 504A, 504B, 606) of the display device 400.

In various examples, the controller 402 determines a distance (e.g., the distance 112, 212) from the image sensor to the user by utilizing the image. The controller 402 utilizes the techniques described above with respect to FIG. 1 or 2 to determine the distance, for example. In response to a determination that the distance is within the threshold range, the controller 402 determines that the user is visually impaired. In some examples, the controller 402 stores the size to which the GUI is adjusted and the distance to the storage device 404.

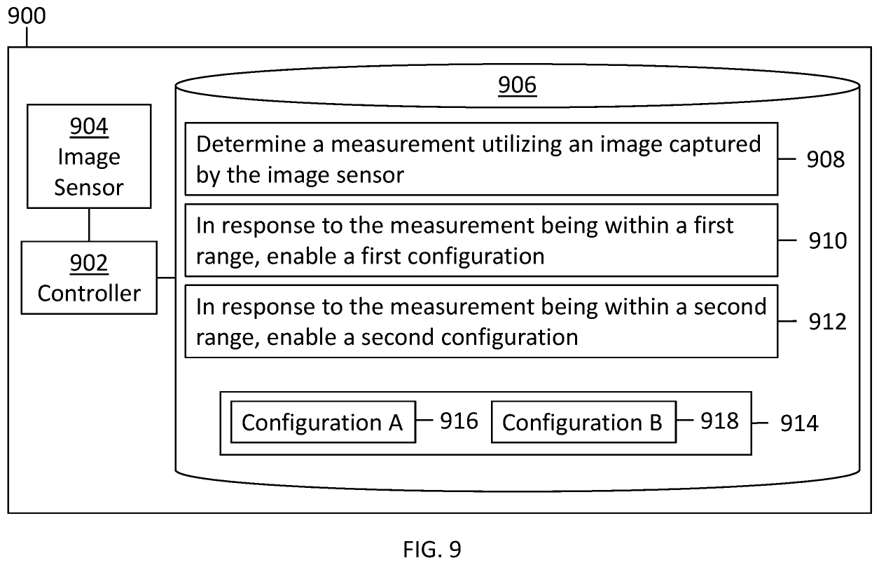

In some examples, the distance is a first distance, and the controller 402 receives a second image from the image sensor. The controller 402 determines a second distance from the image sensor to the user by utilizing the second image. In response to a determination that the second distance is less than the first distance, the controller 402 adjusts the size of the GUI for adjusting the settings of the display device 400. In various examples, the controller 402 stores the size to which the GUI is adjusted and the second distance to the storage device 404. In some examples, the controller 402 stores the size associated with the first distance and the first distance to a first configuration and the size associated with the second distance and the second distance to a second configuration, as described below with respect to FIG. 9.

In various examples, the controller 402 detects an eye anomaly (e.g., the eye anomaly 318) by utilizing the image. The controller 402 detects the eye anomaly by utilizing the techniques described above with respect to FIG. 1, 2, or 3, for example. In response to detecting the eye anomaly, the controller 402 determines that the user is visually impaired.

In response to a determination that the user is within the threshold distance, moving closer to the display device 400, has the eye anomaly, or a combination thereof, the controller 402 determines that the user is visually impaired. In response to the determination that the user is visually impaired, the controller 402 adjusts a size of the menu of the display device 400, enables text-to-speech executable code, or a combination thereof.

In some examples, the text-to-speech executable code is stored to the display device 400. For example, the text-to-speech executable code is stored to the storage device 404. In another example, the text-to-speech executable code is stored to a storage device of a speech synthesis circuitry (not explicitly shown). The speech synthesis circuitry receives data from a scaler circuitry (not explicitly shown) of the display device 400. The data includes a description of the menu, a description of the GUI that enables access to the menu, the text of the menu, a description of the icons of the menu, a position of a selection of a menu option, or a combination thereof. The speech synthesis circuitry causes an audio device (e.g., the audio device 110, 210) to play the data, for example. In another example, executing the text-to-speech executable code by the controller 402 causes the controller 402 to cause the audio device to play the data.

In other examples, the text-to-speech executable code is stored to an electronic device (e.g., the electronic device 102) communicatively coupled to the display device 400. The controller 402 causes transmission of the data from the scaler circuitry to the electronic device.

Referring now to FIGS. 5A and 5B, block diagrams of display device settings sizes for a display device 500 are shown, in accordance with various examples. The display device 500 is a display device 106, 202, 400, for example. The display device 500 includes an image sensor 502. The image sensor 502 is the image sensor 108, 208, for example.

Referring now to FIG. 5A, the display device 500 displays a GUI 504A. The GUI 504A displays a menu option. The menu option is for a user (e.g., the user 100, 200) to determine an input source of the display device 500, for example. The GUI 504A includes input source options “Auto,” “VGA,” “DP,” “HDMI” as well as multiple arrows for selecting the input source. The multiple arrows include an upward pointing arrow, a downward pointing arrow, a rightward pointing arrow, and a leftward pointing arrow, for example. In some examples, the arrows correspond to buttons (not explicitly shown) disposed on a frame of the display device 500. The buttons enable the user to select the input source.

Referring now to FIG. 5B, the display device 500 displays a GUI 504B. The GUI 504B displays a menu option. The menu option is for the user to determine the input source of the display device 500, for example. The GUI 504B includes input source options “Auto,” “VGA,” “DP,” “HDMI” as well as multiple arrows for selecting the input source. The multiple arrows include an upward pointing arrow, a downward pointing arrow, a rightward pointing arrow, and a leftward pointing arrow, for example. In some examples, the arrows correspond to buttons (not explicitly shown) disposed on a frame of the display device 500. The buttons enable the user to select the input source.

Referring now to FIGS. 5A and 5B, in various examples, the GUI 504B is the GUI 504A having adjusted sizes. For example, in response to a determination that a user (e.g., the user 100, 200) is visually impaired utilizing an image captured by the image sensor 502, a controller (e.g., the controller 402) adjusts the display device setting sizes of the GUI 504A to generate the GUI 504B.

Referring now to FIG. 6, a block diagram of display settings sizes for a display device 600 is shown, in accordance with various examples. The display device 600 is the display device 106, 202, 400, 500, for example. The display device 600 includes an image sensor 602, an audio device 604, and a GUI 606. The image sensor 602 is the image sensor 108, 208, 502, for example. The audio device 604 is the audio device 110, 210, for example. The GUI 606 is the GUI 504A, 504B, for example.

The GUI 606 displays a menu option. The menu option is for a user (e.g., the user 100, 200) to determine an input source of the display device 600, for example. The GUI 606 includes input source options “Auto,” “VGA,” “DP,” “HDMI” as well as multiple arrows for selecting the input source. In some examples, the arrows correspond to buttons (not explicitly shown) disposed on a frame of the display device 600. The buttons enable the user to select the input source.

In various examples, the GUI 606 is the GUI 504A having adjusted sizes, and the audio device 604 plays the menu options, a selection of the menu options, or the combination thereof. For example, in response to a determination that the user is visually impaired utilizing an image captured by the image sensor 602, a controller (e.g., the controller 402) adjusts the display device setting sizes of the GUI 504A to generate the GUI 606.

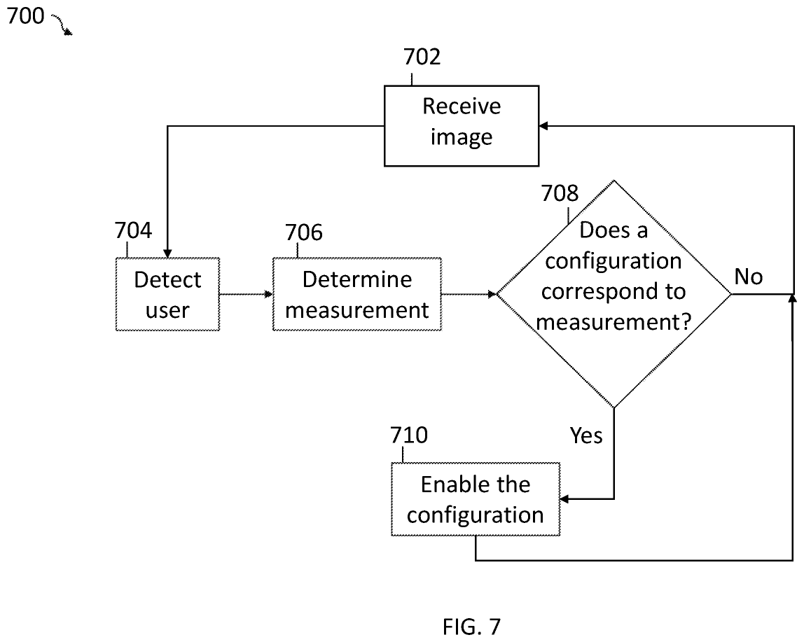

Referring now to FIG. 7, a flow diagram of a method 700 for adjusting display device settings sizes is shown, in accordance with various examples. The method 700 includes receiving an image (block 702). The method 700 also includes detecting a user (e.g., the user 100, 200) (block 704). Additionally, the method 700 includes determining a measurement (block 706). The method 700 includes determining whether a configuration corresponds to the measurement (block 708). In response to a determination that the configuration does not correspond to the measurement, the method 700 also includes returning to receive another image. In response to a determination that the configuration does correspond to the measurement, the method 700 additionally includes enabling the configuration (block 710).

The method 700 is performed by the electronic device 102, the display device 106, 202, 400, 500, 600, for example. A controller (e.g., the controller 402) receives the image from an image sensor (e.g., the image sensor 108, 208, 502, 602), for example. The controller detects the user utilizing the techniques described above with respect to FIG. 1, 2, or 3, for example. The controller determines the measurement utilizing the techniques described above with respect to FIG. 1, 2, or 3, for example. The measurement is a distance from the user to the image sensor, a measurement of an eye feature, or a combination thereof, for example. In various examples, the controller determines whether the configuration corresponds to the measurement utilizing the techniques described above with respect to FIG. 4 or described below with respect to FIG. 9, for example. To enable the configuration, in some examples, the controller adjusts a size of the menu of the display device, enables text-to-speech executable code, or a combination thereof.

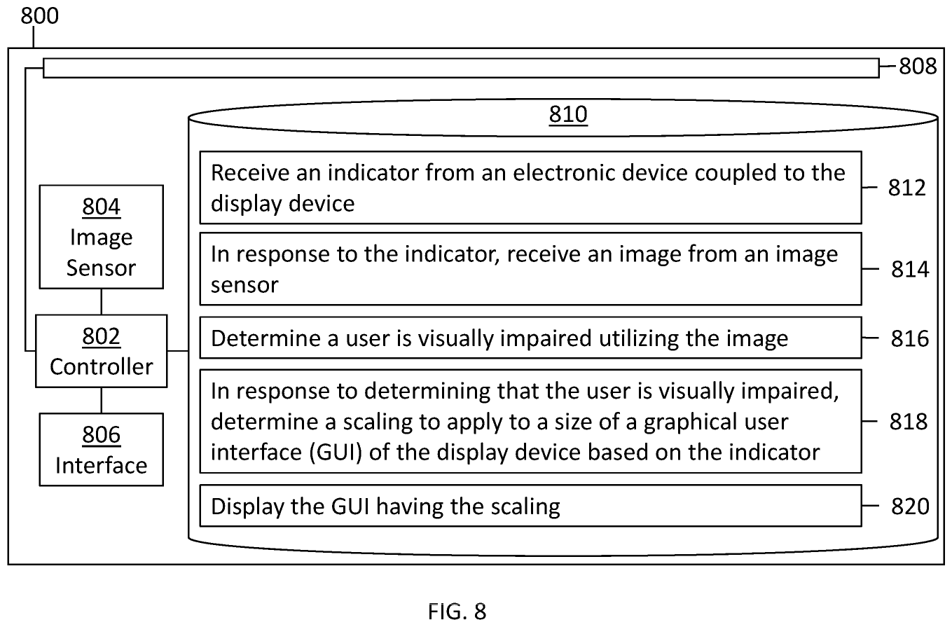

Referring now to FIG. 8, a block diagram of a display device 800 for adjusting display device settings sizes is shown, in accordance with various examples. The display device 800 is the display device 106, 202, 400, 500, 600, for example. The display device 800 includes a controller 802, an image sensor 804, an interface 806, a display panel 808, and a storage device 810. The controller 802 is the controller 402, for example. The image sensor 804 is the image sensor 108, 208, 502, 602, for example. The interface 806 enables an electronic device (e.g., the electronic device 102) to couple to the display device 800. The interface 806 is USB, VGA, DVI, HDMI, BLUETOOTH®, or WI-FI®, for example. The display panel 808 is an LCD panel, an LED panel, a plasma panel, a QD-LED panel, an OLED panel, or other suitable display panel. The storage device 810 is the storage device 404, for example.

In various examples, the controller 802 is coupled to the image sensor 804, the interface 806, the display panel 808, and the storage device 810. The image sensor 804 is coupled to the controller 802. The interface 806 is coupled to the controller 802. The display panel 808 is coupled to the controller 802. The storage device 810 is coupled to the controller 802.

In some examples, the storage device 810 stores machine-readable instructions 812, 814, 816, 818, 820, which, when executed by the controller 802, cause the controller 802 to perform some or all of the actions attributed herein to the controller 802. For example, the machine-readable instructions 812, 814, 816, 818, 820, when executed by the controller 802, cause the controller 802 to determine a user (e.g., the user 100, 200) is visually impaired and adjust display device settings sizes in response to the determination that the user is visually impaired.

In some examples, the machine-readable instruction 812, when executed by the controller 802, causes the controller 802 to receive an indicator from an electronic device (e.g., the electronic device 102) coupled to the display device 800. The machine-readable instruction 814, when executed by the controller 802, causes the controller 802 to receive an image (e.g., the image 300, 320) from the image sensor 804. The machine-readable instruction 816, when executed by the controller 802, causes the controller 802 to determine a user (e.g., the user 100, 200) is visually impaired utilizing the image. In response to determining that the user is visually impaired, the machine-readable instruction 818, when executed by the controller 802, causes the controller 802 to determine a scaling to apply to a size of a GUI of the display device 800 based on the indicator. The machine-readable instruction 820, when executed by the controller 802, causes the controller 802 to display the GUI having the scaling.

In various examples, the indicator from the electronic device is a size of a text, an icon, or a combination thereof, an indicator that a text-to-speech executable code is executing on the electronic device, or a combination thereof. The indicator indicates that the user is visually impaired, for example. To verify that the user is visually impaired, the controller 802 receives the image and determines whether the user is visually impaired utilizing the image. The controller 802 uses the techniques described above with respect to FIG. 1, 2, or 3 to determine the user is visually impaired, for example.

In some examples, the indicator from the electronic device indicates a text size. The controller 802 determines the scaling such that the size of a text of the GUI for adjusting settings of the display device 800 is equivalent to the text size. In various examples, the controller 802 stores the scaling to the storage device 810.

In various examples, the controller 802 causes transmission of data associated with the scaling to a text-to-speech executable code. In some examples, the text-to-speech executable code is stored on the electronic device. In other examples, the storage device 810 stores the text-to-speech executable code. Execution of the machine-readable instructions of the text-to-speech executable code by the controller 802 causes the controller 802 to convert the data associated with the scaling to speech and cause the audio device (e.g., the audio device 110, 210) to output the speech. In some examples, the audio device is an audio device of the display device 800. In other examples, the audio device is an audio device of the electronic device.

Referring now to FIG. 9, a block diagram of a display device 900 for adjusting display device settings sizes is shown, in accordance with various examples. The display device 900 is the display device 106, 202, 400, 500, 600, 800, for example. The display device 900 includes a controller 902, an image sensor 904, and a storage device 906. The controller 902 is the controller 402, 802, for example. The image sensor 904 is the image sensor 108, 208, 502, 602, 804, for example. The storage device 906 is the storage device 404, 810, for example.

In various examples, the controller 902 is coupled to the image sensor 904 and the storage device 906. The image sensor 904 is coupled to the controller 902. The storage device 906 is coupled to the controller 902.

In some examples, the storage device 906 stores machine-readable instructions 908, 910, 912, which, when executed by the controller 902, cause the controller 902 to perform some or all of the actions attributed herein to the controller 902. For example, the machine-readable instructions 908, 910, 912, when executed by the controller 902, cause the controller 902 to determine a user (e.g., the user 100, 200) is visually impaired and adjust display device settings sizes in response to the determination that the user is visually impaired. The storage device 906 includes configurations 914. The configurations 914 include a Configuration A 916 and a Configuration B 918.

In some examples, the machine-readable instruction 908, when executed by the controller 902, causes the controller 902 to determine a measurement utilizing an image (e.g., the image 300, 320) captured by the image sensor 904. In response to the measurement being within a first range, the machine-readable instruction 910, when executed by the controller 902, causes the controller 902 to enable a first configuration. In response to the measurement being within a second range, the machine-readable instruction 912, when executed by the controller 902, causes the controller 902 to enable a second configuration.

In various examples, the measurement is a distance from the user to the image sensor, a measurement of an eye feature, or a combination thereof. The controller determines the measurement utilizing the techniques described above with respect to FIG. 1, 2, or 3, for example. In examples in which the measurement is the distance, the first range is a range having the threshold distance as a first boundary and a location of the image sensor 904 as a second boundary, and the second range is a range having the threshold distance as a first boundary and a second threshold distance as a second boundary. The second threshold distance is disposed further away from the image sensor 904. In examples in which the measurement is of the eye feature, the first range is a specified range for a first eye feature and the second range is a specified range for a second eye feature. For example, the first range indicates a first eye condition associated with the first eye feature and the second range indicates a second eye condition associated with the second eye feature.

In some examples, the controller 902 determines the distance from the image sensor 904 to the user utilizing the image. In response to determining that the distance is within the first range, the controller 902 determines that the user is a first user. In response to determining that the distance is within the second range, the controller 902 determines that the user is a second user.

In other examples, the measurement is a diameter of an eye feature. The controller 902 determines the diameter of the eye feature utilizing the image. In response to determining that the diameter is within the first range, the controller 902 enables the first configuration. In response to determining that the diameter is within the second range, the controller 902 enable the second configuration.

In various examples, the controller 902 determines a second measurement utilizing a second image captured by the image sensor 904. In response to the measurement not being within the first range or the second range, the controller 902 determines a scaling to apply to a size of the GUI for adjusting settings of the display device based on an indicator received from an electronic device (e.g., the electronic device 102). The controller 902 stores the scaling and the measurement to a third configuration on the storage device 906.

In other examples, the first configuration includes a first size of a menu for adjusting display device settings sizes and the second configuration includes a second size of the menu. The display device 900 includes an audio device (e.g., the audio device 110, 210). The storage device 906 stores a text-to-speech executable code. Execution of machine-readable instructions of the text-to-speech executable code causes the controller 902 to convert the data of the menu to speech and cause the audio device to output the speech.

In some examples, the configurations 914 are different configurations for a single user. In other examples, the configurations 914 include configurations for different users.

Unless infeasible, some or all of the method 700 may be performed by the electronic device 102, the display device 106, 202, 400, 500, 600, 800, 900 concurrently or in different sequences and by circuitry of the electronic device or the display device, execution of machine-readable instructions of the electronic device or the display device, or a combination thereof. For example, the method 700 is implemented by machine-readable instructions stored to a storage device (e.g., the storage device 404, 810, 906, or another storage device not explicitly shown) of the electronic device or the display device, circuitry (some of which is not explicitly shown) of the display device, or a combination thereof. A controller (e.g., the controller 402, 802, 902) of the electronic device or the display device executes the machine-readable instructions to perform some or all of the method 700, for example.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . ” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. A display device, comprising:
a controller to:
receive an image from an image sensor;
determine a user is visually impaired utilizing the image; and
in response to determining that the user is visually impaired, adjust a size of a graphical user interface (GUI) for adjusting settings of the display device.

2. The display device of claim 1, wherein the controller is to:
determine a distance from the image sensor to the user by utilizing the image; and
in response to a determination that the distance is within a threshold range, determine that the user is visually impaired.

3. The display device of claim 2, comprising a storage device, and wherein the controller is to store the size and the distance to the storage device.

4. The display device of claim 2, wherein the distance is a first distance, and wherein the controller is to:
receive a second image from the image sensor;
determine a second distance from the image sensor to the user by utilizing the second image; and
in response to a determination that the second distance is less than the first distance, adjust the size of the GUI for adjusting the settings of the display device.

5. The display device of claim 1, wherein the controller is to:
detect an eye anomaly by utilizing the image; and
in response to detecting the eye anomaly, determine that the user is visually impaired.

6. A display device, comprising:
an image sensor; and
a controller to:
receive an indicator from an electronic device coupled to the display device;
in response to the indicator, receive an image from the image sensor;
determine a user is visually impaired utilizing the image;
in response to determining that the user is visually impaired, determine a scaling to apply to a size of a graphical user interface (GUI) for adjusting settings of the display device based on the indicator; and
cause a display of the GUI having the scaling.

7. The display device of claim 6, wherein the indicator from the electronic device is to indicate a text size, and wherein the controller is to determine the scaling such that the size of a text of the GUI for adjusting the settings of the display device is equivalent to the text size.

8. The display device of claim 6, comprising a storage device, and wherein the controller is to store the scaling to the storage device.

9. The display device of claim 6, wherein the controller is to cause transmission of data associated with the scaling to a text-to-speech executable code.

10. The display device of claim 9, comprising a storage device storing the text-to-speech executable code and an audio device, and wherein execution of machine-readable instructions of the text-to-speech executable code causes the controller to:
convert the data associated with the scaling to speech; and
cause the audio device to output the speech.

11. A display device, comprising:
a storage device to store a first configuration and a second configuration of a graphical user interface (GUI) for adjusting settings of the display device, the first configuration associated with a first range and the second configuration associated with a second range; and
a controller coupled to the storage device, the controller to:
determine a measurement utilizing an image captured by an image sensor;
in response to the measurement being within the first range, enable the first configuration; and
in response to the measurement being within the second range, enable the second configuration.

12. The display device of claim 11, wherein the measurement is a distance, and wherein the controller is to:
determine the distance from the image sensor to a user utilizing the image;
in response to determining that the distance is within the first range, determine the user is a first user; and
in response to determining that the distance is within the second range, determine the user is a second user.

13. The display device of claim 11, wherein the measurement is a diameter of an eye feature, and wherein the controller is to:
determine the diameter of the eye feature utilizing the image;
in response to determining that the diameter is within the first range, enable the first configuration; and
in response to determining that the diameter is within the second range, enable the second configuration.

14. The display device of claim 11, wherein the controller is to:
determine a second measurement utilizing a second image captured by the image sensor; and
in response to the measurement not being within the first range or the second range, determine a scaling to apply to a size of a GUI for adjusting settings of the display device based on an indicator received from an electronic device, and store the scaling and the measurement to a third configuration on the storage device.

15. The display device of claim 11, comprising an audio device, wherein the first configuration includes a first size of a menu for adjusting display device settings sizes and the second configuration includes a second size of the menu, wherein the storage device is to store text-to-speech executable code, and wherein execution of machine-readable instructions of the text-to-speech executable code causes the controller to:
convert data of the menu to speech; and
cause the audio device to output the speech.
